(19) United States
(12) Patent Application Publication
(10) Pub. No.: US 2014/0168758 A1
(43) Pub. Date: Jun. 19, 2014

(54) CARBON AS GRAZING INCIDENCE EUV MIRROR AND SPECTRAL PURITY FILTER

(71) Applicant: KLA-Tencor Corporation, (US)

(72) Inventors: Garry Rose, Livermore, CA (US); Guorong Vera Zhuang, Santa Clara, CA (US); Gildardo Delgado, Livermore, CA (US); Qiang Zhang, San Jose, CA (US)

(73) Assignee: KLA-TENCOR CORPORATION, Milpitas, CA (US)

(21) Appl. No.: 13/839,570

(22) Filed: Mar. 15, 2013

Related U.S. Application Data
(60) Provisional application No. 61/736,709, filed on Dec. 13, 2012.

(51) Int. Cl. G02B 5/08

(52) U.S. Cl. CPC G02B 5/0891
USPC 359/359

(57) ABSTRACT

A mirror for reflecting extreme ultraviolet light (EUV) comprising: a substrate layer; and an upper layer above the substrate layer, that reflects EUV wavelengths and refracts longer wavelengths, said upper layer being dense and hard carbon having an Sp2 to Sp3 carbon bond ratio of 0 to about 3 and a normal incidence EUV mirror comprising an optical coating on an uppermost surface which permits transmission of EUV and protects the surface from environmental degradation, said coating being dense and hard and having an Sp2 carbon bond ratio of 0 to about 3 and a thickness of 0.1 to about 5 nanometers. The invention also includes EUV mirror systems protected by a dense carbon layer and includes a multilayer EUV reflecting system having an out of band absorbing layer.

### BACKGROUND OF THE INVENTION

This application claims the benefit under 35 U.S.C. §119(e) of U.S. Provisional Application No. 61/736,709, filed Dec. 13, 2102.

Among the most widely used grazing incident mirrors for reflecting EUV in-band (λ=13.5 plus or minus 2%) are Ru, Mo and Nb. These materials were also used as an EUV multilayer mirror capping layer.

Although old methods have high reflectivity towards EUV, they are susceptible to surface contamination and oxidation by EUV irradiation under vacuum in the presence of residual water, as well as hydrocarbon contamination under EUV irradiation. The amount of oxide on the grazing incident mirror made of Ru, Mo and Nb, or on the capping layer made of Ru, Mo and Nb, on normal incident multilayer mirrors (ML), need to be very thin, e.g. 2 to 2.5 nanometers. Otherwise, the in-Band EUV reflectivity would decrease, since each of the metal oxide is more absorbing than the non-oxidized metal for in-band EUV. To recover the in-band EUV reflectivity loss, the oxide layer must be chemically reduced using atomic hydrogen to remove the oxide and restore the metal. The need for oxide removal imposes a repair cycle (impacting tool utilization), shortens optics lifetime, and adds contamination risk from metal hydrides.

Carbon deposits, as a result of Hydrocarbon (HC) contaminants interaction with EUV, are undesirable for both normal and grazing incidence EUV optics, since carbon contamination reduces the inband EUV reflectivity in a non-uniform way. Such carbon deposits start off as low density, hydrogenated, and in polymeric carbon form. With prolong EUV exposure, the carbonaceous contamination film develops on the surface of EUV mirrors which is exposed to light. The contamination layer grows on the surface from the dissociation of residual hydrocarbons in this light exposure region.

### BRIEF SUMMARY OF THE INVENTION

In accordance with the invention, a mirror for extreme ultraviolet light (EUV) is provided that overcomes or reduces disadvantages as previously described.

A general purpose of this invention is to enhance the EUV (in the 3 nanometers to 20 nanometer spectrum band) inband reflectivity for grazing incident optical components while suppressing the reflectivity at other spectral regions. Another purpose is to provide a grazing optical mirror with enhanced surface hardness, chemical inertness, high thermal conductivity, low thermal expansion and compatible to substrates, such as Si, Quartz, etc. or use on metal substrates. This invention thus can achieve a long life time of optics. Current Ru grazing angle mirrors require use of hydrogen to periodically clean of RuOₓ and carbon contamination. The current invention allows for alternatives to reduce and eliminate H₂ use in the system while meeting the optics lifetime requirements.

In accordance with the invention, at grazing incident angles (70 to 88.9.), engineered high density carbon films having high Sp3 content, e.g. tetrahedral (Ta-C), are expected to have high reflectivity in EUV. This unique feature, in combination with reduced sensitivity to carbon contamination and reduced impact from oxygen attack and, available deposition methods and known material properties, makes high density carbon an attractive coating for grazing EUV mirrors, especially mirrors for grazing surface angles of 0 to 20 degrees.

These properties also make carbon attractive as an optical coating and capping layer of normal incident multilayer (ML) mirrors and other EUV optical components and detectors. Although low density, hydrogenated, polymeric carbon is known to be removed by atomic hydrogen, high density carbon (e.g ta-C) is much more resistant to atomic hydrogen attack. Another unique feature of Ta-C is that its material properties can be customized to fit the applications. Ideal operating conditions would still control amounts of carbon reactive species (H₂, H₂O, O₂).

More particularly, the invention comprises a mirror for reflecting extreme ultraviolet light (EUV) comprising: a substrate layer; and an upper layer above the substrate layer, that reflects EUV wavelengths and refracts longer wavelengths, said upper layer being dense and hard carbon having an Sp2 to Sp3 carbon bond ratio of 0 to about 3 and a normal incidence EUV mirror comprising an optical coating on an uppermost surface which permits transmission of EUV and protects the surface from environmental degradation, said coating being dense and hard and having an Sp2/Sp3 carbon bond ratio of 0 to about 3 and a thickness of 0.1 to about 5 nanometers.

Further, in a particular embodiment, the invention includes a multilayer EUV reflecting system having a plurality of EUV reflecting layers and at least one absorbing layer for absorbing out of EUV band radiation. In a preferred embodiment, the absorbing layer is an out of EUV band absorbent selected from the group consisting of anthracene, naphthalene, perylene and mixtures thereof.

### BRIEF DESCRIPTION OF THE SEVERAL VIEWS OF THE DRAWINGS

The nature and mode of operation of the present invention will now be more fully described in the following detailed description of the invention taken with the accompanying drawing figures, in which:

FIG. 1 a phase diagram of bonding in amorphous carbon-hydrogen alloys

FIG. 2A is a graph showing reflectivity of Ru at a grazing incidence normal angle of 88.6 degrees.

FIG. 2B is a graph showing simulated broadband reflectivity of diamond and graphite at a grazing incidence normal angle of 88° and 89°. Comparison with FIG. 2A clearly shows EUV reflectivity of both diamond and graphite is comparable to Ru at a normal angle of 88.6 and that reflectivity of diamond and graphite in the spectral range of 100-350 nm is significantly lower than Ru.

FIG. 3 shows spectral absorbance the DUV band for benzene, anthracene, naphthalene and perylene.

FIG. 4 shows an embodiment of a grazing angle mirror 10 in accordance with the present invention

FIG. 5 shows a mirror similar to FIG. 4 except an OOB absorbing layer 28 is provided that absorbs most refracted OOB radiation.

FIG. 6 illustrates a multilayer system showing a normal incident ray 14 having EUV components (solid line) and OOB components (dotted line).

### DETAILED DESCRIPTION OF THE INVENTION

The following defined terms and definitions assist in understanding the metes and bounds of the invention.

“HC” means hydrocarbon.

“High density carbon” is carbon having a specific gravity of at least 2.0 g/cm² and has an Sp2/Sp3 ratio of 0 to 3.

“Hard carbon” is carbon having the hardness of high density carbon but is desirably 40-120 Gpa and most desirably at least 40 Gpa.

“Ta-C” means a high density hard carbon form having an Sp2/Sp3 ratio of 0.1 to 1.5 with no more than five percent hydrogen-carbon bond content by stochiometry.

“Diamond-like carbon”; “DLC” is high density carbon having a ratio of Sp2/Sp3 carbon-carbon bond of 1.5 to 1.7.

“UV” radiation, as used herein, means radiation having a wavelength between 3 and 400 nm.

“DUV” is deep UV radiation (also sometimes referred to as damaging UV radiation) having a wavelength of 22 to 330 nm.

“NIR” means near infrared radiation, wave length to 0.9 to 2.4 microns.

“VIS” is visible light of a wavelength of 400 to 900 nm.

“VUV” is UV radiation having a wavelength of 20 to 190 nanometers.

“Out of band” refers to wave lengths other than EUV″

“OOB” is an abbreviation for out of band.

“n” and “k” are refractive index and extinction coefficient respectively.

“Sp3” bond (σ) is a symmetrical carbon-carbon bond employing an Sp3 hybrid orbital of each carbon atom.

“Sp2” bond (π) is an asymmetrical carbon-carbon bond employing Sp2 orbitals of the carbons.

“Mirror surface” is a surface that reflects extreme ultraviolet light.

“Extreme ultraviolet light”, as used herein, refers to electromagnetic radiation within the spectrum wavelength band of 3 nanometers to 20 nanometers.

“EUV” is an abbreviation for extreme ultraviolet light including long wavelength soft x-rays where the EUV has a wavelength of 3 to 20 nm.

“Incident radiation” or “incident light” is incoming radiation or light striking the mirror surface.

“Incident angle” or “Angle of Incidence” is the angle at which incident radiation strikes the mirror surface. The angle may be defined either with respect to the mirror surface (“surface angle”) or with respect to perpendicular (normal) to the mirror surface (“normal angle”). The surface angle and normal angle of a particular incident beam of radiation are complementary angles.

“AOI” is an abbreviation for angle of incidence.

“Normal incidence” is an incident angle within 45 degrees from perpendicular normal) to the mirror surface.

“Grazing incidence” is an incident angle from 45 degrees to under 90 degrees from perpendicular (normal) to the mirror surface. “Grazing incidence” may also be defined as an incident angle of 0 to 45 degrees from the mirror surface (surface angle).

In accordance with the invention, high density carbon coatings and films are provided in optics that have desirable physical properties including resistance to environmental degradation, EUV reflectance, and OOB transmission.

The High density carbon films and coatings usually have a carbon-carbon Sp2 to Sp3 carbon bond ratio of 0 to about 3. Ranges; however, may be variable within the 0 to 3 ratio for particular desired properties, e.g. hardness, reflectance, density and inert character. Such restricted Sp2/Sp3 ratios are for example 0 to about 1.85; 1.5 to about 1.7; and 1.5 to about 3

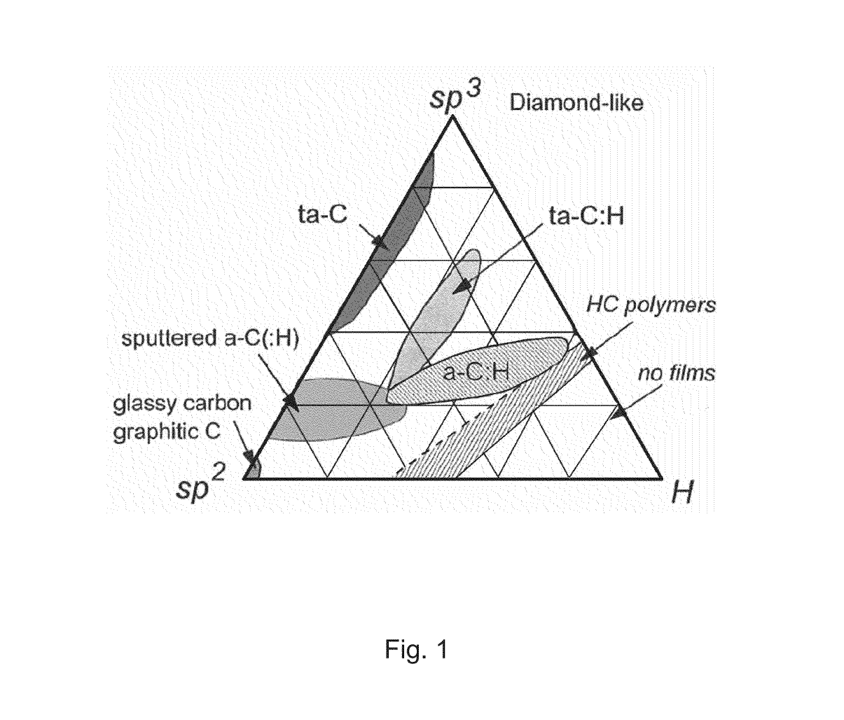

As an aid to understanding the invention a phase diagram of bonding in amorphous carbon-hydrogen alloys is shown in FIG. 1. The physical properties and structure of Ta-C are largely determined by fraction of Sp3 bonded carbon sites and no more than five percent stochiometric hydrogen content.

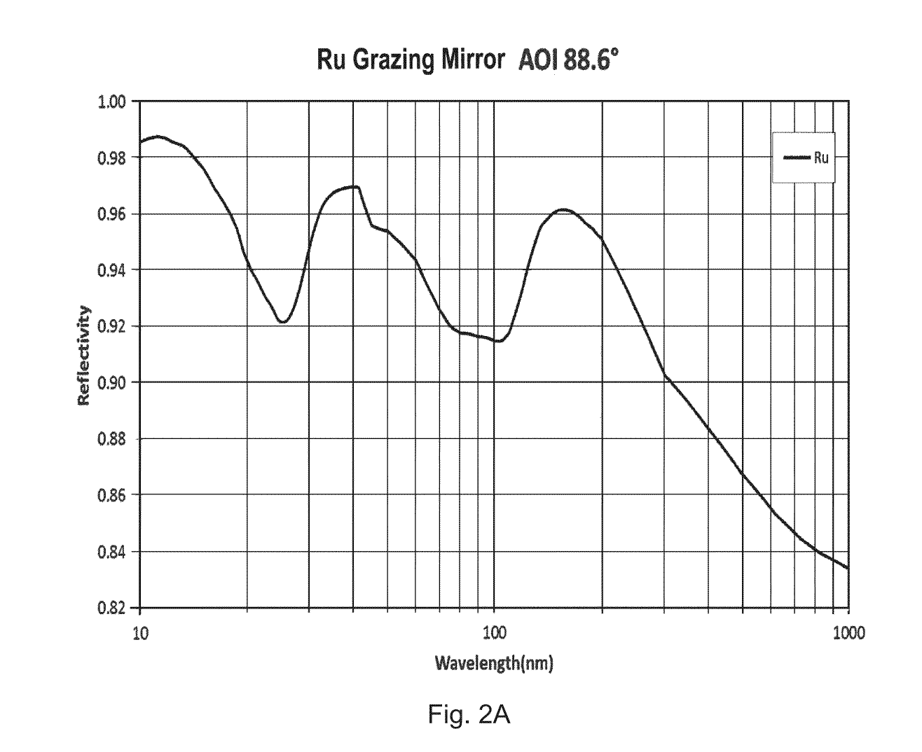

Various forms of carbon and their density are Listed in Table 1. The optical constants of various forms of carbon in EUV (5-40 nm) are known to be related to its density, and could be predicted from the carbon atomic scattering factor and density. The optical constants of diamond, diamond like carbon (e.g. Ta-C) and graphite in the spectral region 40˜1100 nm are readily available in the literature. Using those known optical constants, the broadband reflectivity of diamond and graphite at grazing incidence of 88° and 89° were simulated (FIG. 2B). As clearly shown by the simulation, EUV reflectivity of both diamond and graphite is comparable to Ru at 88.6° (FIG. 2A). Yet, the reflectivity of the former in the spectral range of 100-350 nm is significantly lower than Ru.

The most promising carbon film, suitable for grazing incident mirrors, capping layers and optical coating of EUV optic components, is high density carbon film (e.g. ta-C). A subcategory having higher hardness and more Sp3 character is defined here as tetrahedral carbon (ta-C). As shown in the table, ta-C has properties ranging from diamond to graphite. Its thermal conductivity and hardness can be comparable to diamond and can be made to have enhanced chemical inertness. Its optical properties can be engineered using different deposition methods, e.g. magnetron sputtering, plasma enhanced chemical vapor deposition (PECVD), filtered cathodic vacuum arc (FCVA) and radio frequency plasma enhanced chemical vapor deposition (RF-PECVD), vapor deposition, ion beam sputtering, pulse laser deposition; under deposition gas environment and deposition temperature. By adjusting the deposition conditions, the relative ratio of Sp3 bond (σ) and Sp2 bond (σ-π) in films, the physical properties such as optical constants (n & k), thermal conductivity, electrical conductivity, mechanical strength and roughness of high density carbon can be adjusted. Higher Sp3 content in carbon films make the films more diamond like, while higher contents of Sp2 in carbon film make it more graphitic or amorphous. Thus, the optical coating can be deposited by design to achieve required thermal conductivity, mechanical strength, and optimized EUV reflectivity in relation to other radiations.

As illustrated in Table 1, the optical band gap of high density carbon films can be readily modified by doping the film to increase the Sp2 to Sp3 ratio. In the current application, it is preferable to decrease the optical bandgap in order to suppress the OOB. The optical band gap of high density films can also be modified by doping. For example, P, Si and N are used as dopants to increase the ta-C optical bandgap, thus improving the optical transparency in OOB wavelengths. See e.g. U.S. Pat. No. 6572935 incorporated by reference. However, in this application, other dopants are needed to decrease the optical bandgap in order to make ta-C coating act as spectral filter. Such a dopant to reduce band gap is silver (0-20%). Other such possibilities are copper (0 to 5%) and gold (0-10%). The quantity of dopant should not be so high as to negatively impact the amount of Sp3 character desired, create an easily attacked surface or to reduce hardness below a certain level. Such dopants can be included during chemical vapor deposition, physical vapor deposition or ion implementation.

TABLE 1
Known forms of carbon, their density and optical constants.

| | | | | Diamond | Diamond | | | | |
|---|---|---|---|---|---|---|---|---|---|
| | | Diamond | Diamond | like | like | | | | |
| | | like | like | carbon3 | carbon4 | | | EUV | |
| | | carbon1 (ta- | carbon2 | a-C:H | a-C:H | | | induced | |
| Species | diamond | C) | (ta-C:H) | hard | soft | HOPG | graphite | carbon | Polyethylene |
| Density | 3.52 | ~3.1 | 2.4 | 1.6-2.2 | 1.2-1.6 | 2.266 | 2.267 | 1.2 | 0.92 |
| (g/cm³) | | | | | | | | | |
| Hardness | 100 | 80 | 50 | 10-20 | <10 | | | | 0.01 |
| (Gpa) | | | | | | | | | |
| Sp3 (%) | 100 | 80-88 | 70 | 40 | 60 | | | | 100 |
| H (%) | 0 | 0 | 30 | 30-40 | 40-50 | | | | 67 |
| Gap (eV) | 5.5 | 2.5 | 2-2.5 | 1.1-1.7 | 1.7-4 | | | | 6 |

A primary advantage of the current invention is to reduce unwanted out of band radiation by implementing dense carbon (e.g. ta-C) on an optical element for use with a very steep grazing angle (0 to 10 degree surface angle).

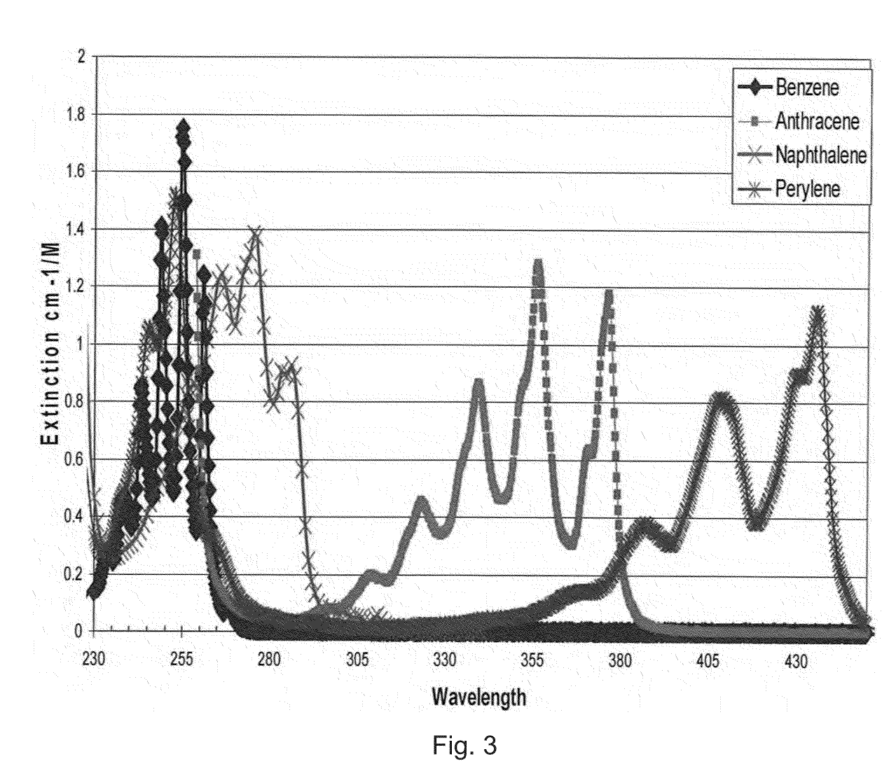

Reference to FIG. 4 shows an embodiment of a grazing angle mirror 10 in accordance with the present invention. An incident beam 14 having EUV components 14 and OOB components 20 strikes mirror surface 16 of high density carbon 12 on substrate 26. As can be seen from FIG. 4 the angle of the beam to the surface 16 is low, e.g. less than 10 degrees surface angle and greater than normal surface angle of 80 degrees from normal 18. EUV is reflected as reflected beam 20 and OOB wave lengths are either refracted through high density carbon 12 in substrate 26 or refracted as OOB output beam 22 at a different angle from EUV output beam 20.

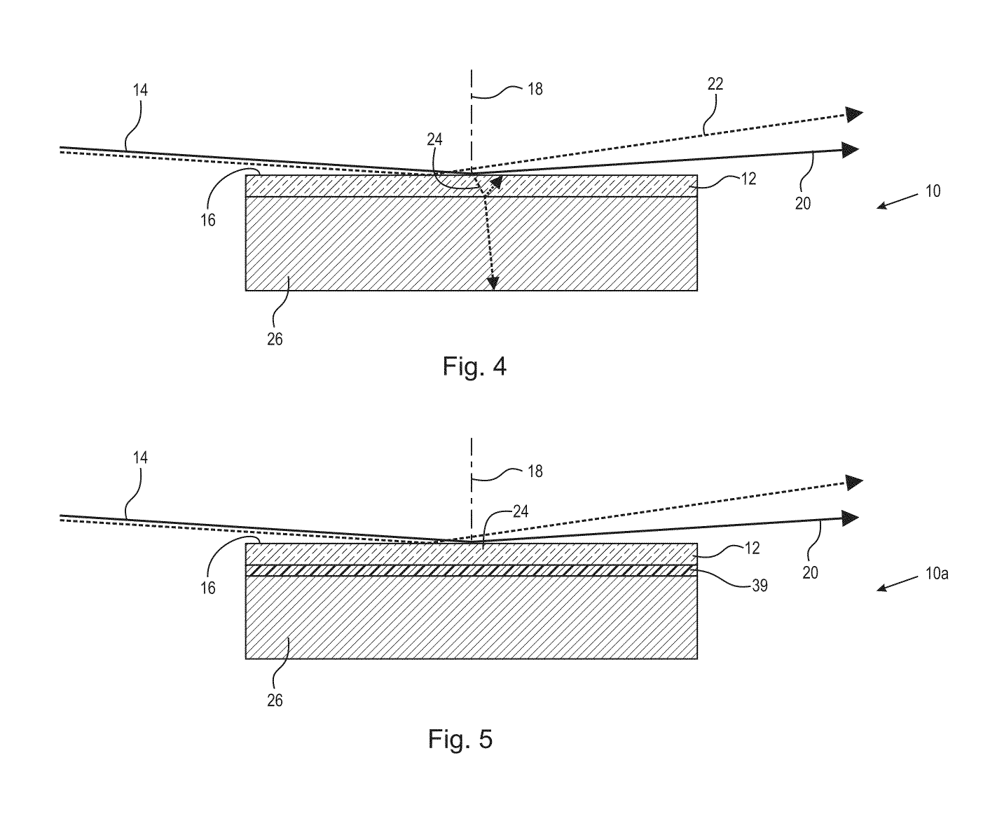

FIG. 5 shows a mirror similar to FIG. 4 except an OOB absorbing layer 28 is provided that absorbs most refracted OOB radiation.

However, the AOI and out of band spectral reflectivity and number of reflections are highly dependent on the dispersion curve (i.e. wavelength dependence of refractive index n and extinction coefficient k. If the hard carbon is designed in such a way to maximize the in-band EUV reflectivity and lower reflectivity in out of band spectral regions, the high density carbon will serve as both a grazing angle reflecting element for inband EUV and as a spectral purity filter for OOB (VUV, DUV, VIS and NIR). Spectral purity filters currently used in EUV systems are foils, and are delicate and must be replaced often. The present invention for spectral purity filters is more robust and may eliminate or reduce the reliance on foil filters.

By modifying the refractive index n and extinction coefficient k at longer wavelength (e.g., 1.02 μm, 150 nm-350 nm), as well as the film thickness, it is possible to modify the refraction angle of OOB light to be less grazing than EUV inband when those OOB exit optical system, thus smaller grazing angle OOB light and NIR light could be eliminated by aperture.

In yet another implementation, high density carbon (e.g. ta-C) films could be deposited on top of highly DUV, VIS and NIR absorbing films such as lithium nitride. The former acts as an EUV reflective layer, while the later as out-of-band absorbing media. The VUV, DUV, VIS and NIR (i.e. OOB) radiation transmitted beyond the ta-C film will be absorbed by lithium nitride. The ta-C would also serve as moisture barrier for the lithium nitride film.

Other advantages of dense carbon coatings such as ta-C coatings are:

1) Environmentally stable, not affected by changing humidity, temperature and pressure;
2) Very low absorbance and scatter
3) Damage resistant to high incident radiation density
4) Ta-C coatings are dense with relative high refractive index, and
5) Low absorption (high absorption coatings are susceptible to radiation damage)

In the preparation of high density carbon grazing incidence mirrors for application in the EUV spectral region, the carbon can be deposited in various morphologies and crystalline structures. Such structures include, but are not limited to, amorphous carbon, crystalline carbon, graphite, and tetrahedral-carbon (ta-C) containing films.

Further, in engineering high density carbon films, e.g. ta-C, with desired optical, thermal and mechanical properties by adjusting the relative abundance of Sp3 bonds with respect to Sp2 bonds, as well as hydrogen content. The more Sp3 bonds, the closer the film is to diamond, and the more the Sp2 bonds, the closer the film more is to graphite film.

Using the above methods, a plurality of critical functions may be optimized in a single film, such as:

a) achievement of high EUV inband reflectivity in conjunction with DUV suppression.

b) adjustment of the character of high density carbon films could within the boundary of polymeric low density carbon and diamond.

c) tuning the optical absorption in the DUV and VIS region by adjusting Sp2 abundance in the ta-C film while maintaining high reflectivity of inband EUV.

Decreasing optical band gap of high density carbon would increase the absorbance of the high density carbon in the OOB spectral region. Such optical band gap of ta-C narrowing could be done by doping with various atomic concentration of Ag Another possible dopant for this purpose is copper. This is an alternative method to increase Sp2 to Sp3 ratio without adding H.

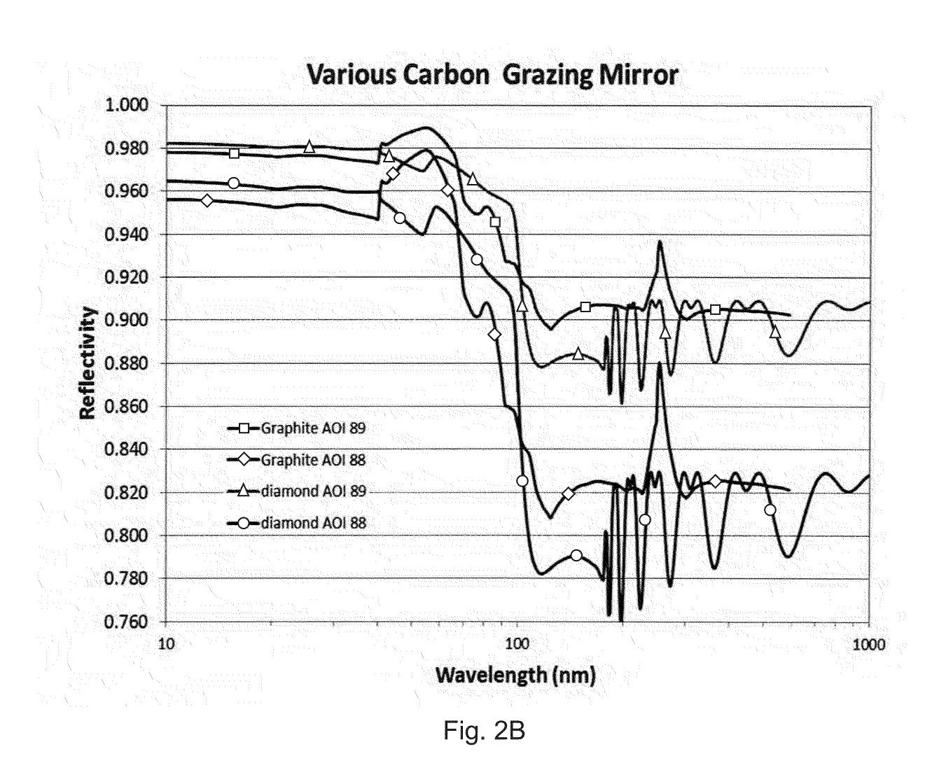

DUV spectral purity filtering could be incorporated in the high density carbon by using a large array of candidate dopants, for example, but not limited to benzene, anthracene, naphthalene and perylene (FIG. 3) for their respective spectral absorbance in DUV.

In an alternative implementation of a spectral purity filter for DUV, a suitable thickness of carbon or Ta-C film (a thickness to achieve high EUV inband reflectivity but less than the penetration depth of OOB) could be deposited on DUV absorbing coatings made of, but not limited to, anthracene, naphthalene and perylene.

Following the same idea as the DUV spectral purity filter, dopants having strong absorbance at appropriate wavelengths. For example, in the case wavelength between 0.9 μm˜2.4 μm in the NIR spectral region could be incorporated absorptive material into the high density carbon films (such as ta-C) films to have maximum absorption for IR lasers and NIR.

The surface of a steep grazing incidence mirror can be made of carbon in the form and density disclosed with thickness varying from angstroms up to microns or more.

The steep grazing incidence mirror may be in the form of various densities of carbon films, as disclosed, deposited on Si, Si3N4, SiO2, quartz, fused silica, glass, metal substrates and preferably on low thermal expansion materials, e.g. metal oxides. Optical and thermal properties of substrates selected desirably match or approximately match properties of the dense carbon film. to achieve the optimum optical response towards inband EUV and effectively filter out OOB. Towards this end, the substrates could also be carbon or carbon composites.

It is further an object of the present invention to provide absorbing layers for OOB radiation that passes through the high density carbon. In an embodiment of this object, a first intermediate layer between the substrate layer and upper layer that absorbs at least some of the refracted longer wavelengths. Further, a series of alternating layers between the substrate and the upper layer may be provided wherein the layers are alternating refracting and absorbing layers for the refracted longer wavelengths.

High density carbon films may also be used for an optical capping layer, e.g. such as multi-layer mirror systems used for organizing incident radiation, e.g. for spectral filters, band separation, band interference systems and beam enhancement.

Such capping can protect the underlying layers from the environment, increase the ta-C absorption at NIR, to impart NIR filtering capability into the capping layer and grazing incidence optical element. Ag, Cu and Au can be doped into high density carbon at various concentrations, e.g. from 0 to 10 percent to reduce band gap.

In such a multilayer system, e.g. a system having alternating silicon and molybdenum layers, one or more layers to absorb refracted OOB may be provided so that reflection of OOB radiation is minimized. In such a case, where reflection of EUV light is the object for normal incident light, the thickness of pairs of the silicon and molybdenum layers is set at one-half of the wave length of the EUV desired so that waves of EUV reflected from different levels are synchronized. If maximum interference between reflected waves is desired, then the thickness is set one-quarter or three-quarters of the wave length so that waves reflected from adjacent layer pairs will interfere.

The presence of an absorbing layer for OOB frequencies is provided, preferably before commencement of silicon/molybdenum pairs, permits EUV to be reflected from the layers essentially free of OOB.

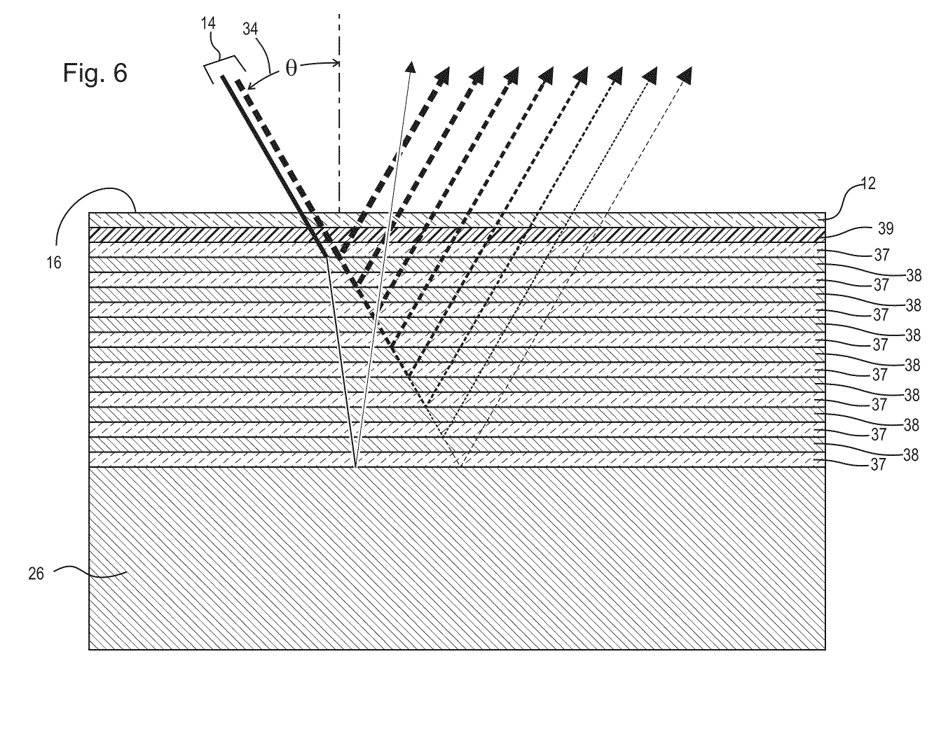

To illustrate such a multilayer system, reference may be had to FIG. 6 showing a normal incident ray 14 having EUV components dotted line) and OOB components (solid line). Because of normal incidence 34, relative to normal 18, the radiation will have better ability to go deeper than a grazing incident ray. As can be seen in FIG. 6, a portion of the EUV reflects from the first Si/Mo pair 37/38 and a portion continues to penetrate to the second pair 37/38 where another portion is reflected, etc. A significant portion of the OOB radiation, having a longer wavelength than EUV, is absorbed by absorbing layer 39, which may, for example, be made of anthracene, naphthalene and perylene or mixtures thereof. The portion of OOB not absorbed is refracted downward and further absorbed reducing reflection back through the top layer to a minimum. When the Si/MO pairs have thickness of one-half of the wave length of the desired EUV, EUV from adjacent layers will be synchronized.

What is claimed is:

1. A mirror for reflecting extreme ultraviolet light (EUV) comprising:
a substrate layer; and
an upper layer above the substrate layer, that reflects EUV wavelengths and refracts longer wavelengths, said upper layer being dense and hard carbon having an Sp2 to Sp3 carbon bond ratio of 0 to about 3.

2. The mirror of claim 1 wherein the dense carbon has an Sp2 to Sp3 bond ratio of 0 to about 1.85.

3. The mirror of claim 1 wherein the dense carbon is diamond-like carbon having an Sp2/Sp3 bond ratio of 1.5 to about 1.7.

4. The mirror of claim 1 where the dense carbon is doped to decrease optical band gap between EUV and other wavelengths.

5. The mirror of claim 4 where the dense carbon has a an Sp2 to Sp3 ratio of about 1.5 to about 3.

6. The mirror of claim 1 wherein the upper layer reflects EUV at a grazing angle of less than ten degrees to the surface of the upper layer.

7. The mirror of claim 1 having a first intermediate layer between the substrate layer and upper layer that absorbs at least some of the refracted longer wavelengths.

8. The mirror of claim 1 that has a series of alternating layers between the substrate and the upper layer wherein the layers are alternating refracting and absorbing layers for the refracted longer wavelengths.

9. A normal incidence EUV mirror comprising an optical coating on an uppermost surface which permits transmission of EUV and protects the surface from environmental degradation, said coating being dense and hard and having an Sp2 to Sp3 carbon bond ratio of 0 to about 3 and a thickness of 0.1 to about 5 nanometers.

10. A multilayer EUV reflecting system having a plurality of EUV reflecting layers and at least one absorbing layer for absorbing out of EUV band radiation.

11. The multilayer EUV reflecting system of claim 10 wherein the reflecting layers have a thickness of one-half wave length of the EUV to be reflected so that EUV reflections from adjacent layers may be synchronized.

12. The multilayer EUV reflecting system of claim 11 wherein each of the EUV reflecting layers is Si/Mo layer pair

13. The mirror of claim 1 having at least one absorbing layer for absorbing out of EUV band radiation.

14. The mirror of claim 13 where the absorbing layer comprises an out of EUV band absorbent selected from the group consisting of anthracene, naphthalene, perylene and mixtures thereof

15. The mirror of claim 10 where the absorbing layer comprises an out of EUV band absorbent selected from the group consisting of anthracene, naphthalene, perylene and mixtures thereof

16. The mirror of claim 9 where the capping layer is doped to alter decrease optical band gap between EUV and other wavelengths.
